(19) United States
(12) Patent Application Publication
(10) Pub. No.: US 2005/0119392 A1
(43) Pub. Date: Jun. 2, 2005

(54) Polypropylene-based composite resin composition

(76) Inventors: Masaru Makagawa, Chiba (JP); Koki Hirano, Chiba (JP); Osamu Isogai, Chiba (JP); Toshifumi Shimazaki, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/501,927

(22) PCT Filed: Feb. 3, 2003
(86) PCT No.: PCT/JP03/01059

(30) Foreign Application Priority Data
Feb. 4, 2002 (JP) 2002-26396

(51) Int. Cl. C08L 1/00

(52) U.S. Cl. 524/451; 524/493; 524/505

(57) ABSTRACT

A polypropylene-based composite resin composition in which: (1) a complex viscosity η* at 190° C. and an angular frequency (ω) of 0.1 rad/s is 2000 Pa·s or more, (2) shear storage moduli G′₁₀₀, G′₁₀, G′_{0.1}, and G′_{0.01} at 190° C. and angular frequencies (ω) of 100, 10, 0.1 and 0.01 rad/s satisfy an equation (I) and an equation (II):
log(G′₁₀₀)−log(G′₁₀)≧0.6 (I)
log(G′_{0.1})−log(G′_{0.01})≦0.4 (II)
and (3) a shear storage modulus G′_{0.0251} at 190° C. and an angular frequency of 0.0251 rad/s is 60 Pa or more. The polypropylene-based composite resin composition reveals less liability to cause failures such as short shot, burrs, surface formation failure, deformation and stringing even when a molding cycle in injection molding is shortened.

### BACKGROUND OF THE INVENTION

The present invention relates to a polypropylene-based composite resin composition which is less liable to cause failures such as short shot, burrs, surface formation failure, deformation and stringing even when a molding cycle in injection molding is shortened.

### RELATED ART

A polypropylene-based composite resin composition is used well in the form of injection-molded parts such as parts for automotives and parts for home electric appliances.

Molding is carried out plural times a day, and therefore if time (molding cycle) required for one molding is long, the number of products which can be molded a day is decreased, so that the cost of the products rise.

However, if such molding as shortening simply molding cycle is carried out, failures such as short shot, burrs, surface formation failure, deformation and stringing occur, and therefore good products can not be obtained.

Accordingly, a material which is less liable to cause the above failures even if molding cycle is shortened is required to be developed.

Japanese Patent Application Laid-Open No. 45969/1998 discloses a polypropylene-based resin composition which is excellent in a balance between a rigidity, a low temperature impact strength and a molding ability comprising polypropylene having a specific melt flow rate (MFR), an elastomer of an ethylene-α-olefin structure having a specific dynamic viscoelastic action and talc and a propylene-based resin composition having an excellent fluidity, a high rigidity and a low temperature impact strength comprising a propylene-ethylene block copolymer having a specific MFR and an ethylene-α-olefin copolymer rubber as materials having an excellent molding ability.

Further, Japanese Patent Application Laid-Open No. 36466/1998 discloses a propylene-ethylene block copolymer in which a molecular weight distribution in a crystalline polypropylene part falls in a specific range and MFR falls in a specific range and which is excellent in a rigidity, an impact resistance and a melt fluidity. Japanese Patent Application Laid-Open No. 002841/2001 discloses a polypropylene composition for car parts which is excellent in a moldability, an appearance, a rigidity and an impact resistance comprising a propylene-ethylene block copolymer having a specific MFR, a styrene-(ethylene/1-butene)-styrene block copolymer having a specific melt index (MI), a styrene-(ethylene/propylene)-styrene block copolymer, an ethylene-α-olefin-based elastomer having a specific MI and talc.

Further, Japanese Patent Application Laid-Open No. 344978/2000 discloses a propylene-based resin composition having a high rigidity, a high impact resistance and a high fluidity comprising two kinds of propylene-ethylene block copolymers in which a intrinsic viscosity falls in a specific range and in which a ratio of a intrinsic viscosity in an ethylene-propylene copolymer part to a intrinsic viscosity in a homopolypropylene part falls in a specific range, or a propylene-ethylene block copolymer, an elastomer having a specific intrinsic viscosity and talc.

However, when the materials disclosed above are used to shorten the molding cycle, the filling time can be shortened, but when the pressure-holding time is shortened, the screw goes back before gate sealing does not sufficiently take place, and therefore back flow of the resin is caused. As a result thereof, surface formation failure and deformation brought about.

Further, when the cooling time is shortened, stringing is caused, so that the strings remain in the cavity and are adhered to a product in subsequent molding to cause inferior appearance.

Accordingly, the materials disclosed above had a limitation in shortening of a molding cycle.

### SUMMARY OF THE INVENTION

The present invention has been made under such circumstances, and an object thereof is to provide a polypropylene-based composite resin composition which is less liable to cause failures such as short shot, burrs, surface formation failure, deformation and stringing even when molding cycle in injection molding is shortened.

Intensive researches repeated by the present inventors in order to achieve the object described above have resulted in coming to complete the present invention.

Namely, the present invention provides:
1. a polypropylene-based composite resin composition in which:
   (1) a complex viscosity η* at 190° C. and an angular frequency (ω) of 0.1 rad/s is 2000 Pa·s or more,
   (2) shear storage moduli G′₁₀₀, G′₁₀, G′_{0.1} and G′_{0.01} at 190° C. and angular frequencies of 100, 10, 0.1 and 0.01 rad/s each satisfy an equation (I) and an equation (II):
      log(G′₁₀₀)−log(G′₁₀)≦0.6 (I)
      log(G′_{0.1})−log(G′_{0.01})≦0.4 (II)
   and (3) a shear storage modulus G′_{0.0251} at 190° C. and an angular frequency of 0.0251 rad/s is 60 Pa or more;
2. the polypropylene-based composite resin composition as described in the above item 1, wherein a capillary viscosity at 190° C. and a shear rate γ of 1216 s⁻¹ is 100 Pa·s or less, and a crystallization temperature at a cooling rate of 10° C./minute measured by means of a differential scanning calolimeter (DSC) is 120° C. or higher;
3. the polypropylene-based composite resin composition as described in the above item 1 or 2, comprising (1) 95 to 50 mass % of a propylene-ethylene block copolymer which comprises (A) a component having a intrinsic viscosity [η] (in decalin of 135° C.) of 0.3 to 2.0 and a stereoregularity index Ic of 95% or more and insoluble in 25° C. p-xylene and boiling n-heptane in an amount of 60 to 96 mass % and (B) a component having a intrinsic viscosity [η] (in decalin of 135° C.) of 1.5 to 9.0 containing 10 mass % or more of a unit originating in ethylene and soluble in 25° C. p-xylene in an amount of 4 to 40 mass %, and which has a melt index (MI) of 20 or more (230° C., 2.16 kgf), (2) 5 to 30 mass % of at least one elastomer having a melt index (MI) of 0.5 to 20 (230° C., 2.16 kgf), (3) 0 to 40 mass % of talc having an average particle diameter of 10 μm or less, (4) 0.3 to 10 mass % of fine powder silica having a primary particle diameter of 0.1 μm or less and (5) 0.0 to 0.3 mass % of a nucleating agent;
4. the polypropylene-based composite resin composition as described in the above item 3, wherein the elastomer is a copolymer of ethylene and α-olefin;
5. the polypropylene-based composite resin composition as described in the above item 3, wherein the elastomer is a styrene-(ethylene/1-butene)-styrene triblock copolymer (SEBS) or a styrene-(ethylene/propylene)-styrene triblock copolymer (SEPS);
6. the polypropylene-based composite resin composition as described in the above item 3, wherein the elastomer comprises two or more selected from a copolymer of ethylene and α-olefin, a styrene-(ethylene/1-butene)-styrene triblock copolymer (SEBS) and a styrene-(ethylene/propylene)-styrene triblock copolymer (SEPS); and
7. the polypropylene-based composite resin composition as described in any of the above items 3 to 6, wherein the fine powder silica is Aerosil.

### BRIEF DESCRIPTION OF THE DRAWINGS

FIG. 1 is a graph showing the relation between an angular frequency co (X-axis) and a shear storage modulus G′ (Y-axis) in Example 3 of the present invention and in Comparative Example 1; and

FIG. 2 is a drawing showing a shape of the specimen (box type product) used for evaluating stringing in the examples of the present invention.

### PREFERED EMBODIMENT FOR CARRYING OUT THE INVENTION

In the polypropylene-based composite resin composition of the present invention, (1) a complex viscosity η* at 190° C. and an angular frequency (ω) of 0.1 rad/s is 2000 Pa·s or more, preferably 5000 Pa·s or more.

The phrase “the complex viscosity η* is 2000 Pa·s or more” means that the (melt) viscosity is high in the region where the shear rate is small. That is, flow of the resin composition in a gate part after filling and replenishing the resin into a die can be stopped soon, and therefore the resin composition melt at the gate part is liable to be solidified. As a result thereof, it contributes to prevention of surface formation failure caused by shortening of the pressure-holding time.

In the case where the complex viscosity η* is less than 2000 Pa·s, the gate sealing time is extended, and therefore deformation and surface formation failure occur when the pressure-holding time is shortened.

A method for controlling the complex viscosity η* to 2000 Pa·s or more includes, for example, (i) increasing an amount of fine powder silica, (ii) increasing an amount of talc, (iii) increasing the amounts of fine powder silica and talc, (iv) increasing an amount of the elastomer added later and (v) elevating a intrinsic viscosity of a 25° C. p-xylene-soluble part in the propylene-ethylene copolymer.

Further, in the polypropylene-based composite resin composition of the present invention, (2) shear storage moduli G′₁₀₀, G′₁₀, G′_{0.1} and G′_{0.01} at 190° C. and angular frequencies (ω) of 100, 10, 0.1 and 0.01 rad/s each satisfy the equations (I) and (II):
log(G₁₀₀)−log(G′₁₀)≧0.6 (I)
log(G_{0.1})−log(G′_{0.01})≦0.4 (II)
The present requisite contributes to prevent stringing of the resin composition.

Accordingly, the resin composition containing more component having a long relaxation time (a long relaxation time component, that is, G′ is large at ω of 0.1 to 0.01 rad/s) is liable to cut in a melt state and less liable to cause stringing. That is, when the long relaxation time component is contained more, polypropylene molecules are not evenly aligned by deformation, and therefore the resin composition is liable to cut causing no stringing.

The value of the equation (I) is 0.6 or more, preferably 0.6 to 2.0 and more preferably 0.7 to 2.0. The value of the equation (II) is 0.4 or less, preferably 0.3 or less.

When the value of the equation (I) is less than 0.6, stringing is liable to occur, and the cooling time can not be shortened. When the value of the equation (II) exceeds 0.4, stringing is liable to occur as well, and the cooling time can not be shortened.

A method for controlling the value of the equation (I) to 0.6 or more includes, for example, a method in which a molecular weight distribution in the polypropylene part is narrowed. A method for controlling the value of the equation (II) to 0.4 or less includes a method in which talc and fine powder silica are added.

Further, in the polypropylene-based composite resin composition of the present invention, (3) a shear storage modulus G′_{0.0251} at 190° C. and an angular frequency of 0.0251 rad/s is 60 Pa or more, preferably 250 Pa or more.

When the shear storage modulus G′_{0.0251} is 60 Pa or more, it contributes to prevent stringing of the resin composition.

Accordingly, the resin composition containing more components having a long relaxation time (the long relaxation time component) is liable to be cut in a melt state and less liable to cause stringing. In other words, it means that if the long relaxation time component is contained more, flow of the molten resin composition does not catch up with deformation that and the resin composition cut (does not cause stringing).

When the shear storage modulus G′_{0.0251} is less than 60 Pa, stringing is liable to occur, and the cooling time can not be shortened.

A method for adjusting the shear storage modulus G′_{0.0251} to 60 Pa or more includes (i) a method in which fine powder silica is added and (ii) a method in which talc is blended with fine powder silica.

Further, in the polypropylene-based composite resin composition of the present invention, (4) a capillary viscosity at 190° C. and a shear rate γ of 1216 s⁻¹ is 100 Pa·s or less, preferably 10 to 80 Pa·s.

Regulating the capillary viscosity to 100 Pa·s or less, that is, a reduction in a viscosity of the molten resin composition makes it possible to shorten time for filling the resin composition into a die and contributes to shortening of the molding cycle.

Regulating the capillary viscosity to 100 Pa·s or less makes it possible to more effectively prevent failures such as short shot and burrs from occurring when a filling time of the resin composition is shortened.

A method for regulating the capillary viscosity to 100 Pa·s or less includes, for example, (i) a method in which an intrinsic viscosity [η] of the component which is insoluble in 25° C. p-xylene and boiling n-heptane in the propylene-ethylene block copolymer is reduced and (ii) a method in which a melt index (MI) of the elastomer is elevated.

Further, in the polypropylene-based composite resin composition of the present invention, (5) a crystallization temperature at a cooling rate of 10° C./minute measured by means of a differential scanning calolimeter (DSC) is 120° C. or higher, preferably 125 to 168° C.

When the crystallization temperature is 120° C. or higher, that is, a crystallization temperature of the resin composition is high, solidification in the gate part is expedited, and surface formation failure caused when shortening the pressure-holding time can be prevented.

Adjusting the crystallization temperature to 120° C. or higher shortens the gate sealing time and makes it possible to more effectively prevent surface formation failure and deformation from occurrence while shortening the pressure-holding time. Further, failures such as spool tearing can more effectively be prevented from being caused when shortening cooling.

A method for adjusting the crystallization temperature to 120° C. or higher includes, for example, a method in which a nucleating agent is added and a method in which a intrinsic viscosity [η] of the part which is insoluble in p-xylene and boiling n-heptane is reduced.

The polypropylene-based composite resin composition of the present invention is a composition comprising a polypropylene base resin, that is, a propylene homopolymer or copolymer and in addition thereto, components other than the above resin such as an elastomer, talc, fine powder silica, a nucleating agent and the like, and a typical example thereof is a composition comprising 95 to 50 mass % of a propylene-ethylene block copolymer, 5 to 30 mass % of at least one elastomer, 0 to 40 mass % of talc, 0.3 to 10 mass % of fine powder silica and 0.0 to 0.3 mass % of a nucleating agent.

The propylene-ethylene block copolymer in the polypropylene-based composite resin composition of the present invention comprises (A) the component which has a intrinsic viscosity [n] (in decalin of 135° C.) of 0.3 to 2.0 and a stereoregularity index Ic of 95% or more and which is insoluble in 25° C. p-xylene and boiling n-heptane in an amount of 60 to 96 mass % and (B) the component which has an intrinsic viscosity [η] (in decalin of 135° C.) of 1.5 to 9.0 and contains 10 mass % or more of a unit originating in ethylene and which is soluble in 25° C. p-xylene in an amount of 4 to 40 mass %, and it has a melt index (MI) of 20 or more (230° C., 2.16 kgf).

The propylene-ethylene block copolymer has a melt index (MI) of 20 or more, preferably 20 to 300.

Adjusting the MI to 20 or more increases the fluidity in filling, and therefore failures such as burrs are not caused. On the other hand, the MI regulated to 300 or less elevates the viscosity at ω of 0.1 rad/s and makes surface formation failure and deformation less liable to occur.

Adjusting a intrinsic viscosity [η] of the component which is insoluble in 25° C. p-xylene and boiling n-heptane to 0.3 or more elevates the viscosity at ω of 0.1 rad/s and makes surface formation failure and deformation less liable to occur. On the other hand, regulating it to 2.0 or less increases the fluidity in a filling step to cause no such failures as burrs.

Further, adjusting the stereoregularity index Ic to 95% or more elevates the crystallization temperature to result in shortening the gate sealing time and therefore makes surface formation failure and deformation less liable to occur while the pressure-holding time is shortened.

Adjusting an intrinsic viscosity [η]of the component which is soluble in 25° C. p-xylene to 1.5 or more elevates the viscosity at ω of 0.1 rad/s and makes surface formation failure and deformation less liable to occur. On the other hand, regulating it to 9.0 or less increases the fluidity in a filling step to cause no such failures as burrs.

Further, adjusting the unit originating in ethylene to 10 mass % or more elevates the crystallization temperature and shortens the gate sealing time, so that surface formation failure and deformation are less liable to be caused when shortening the pressure-holding time.

The propylene-ethylene block copolymer in the polypropylene-based composite resin composition of the present invention can be produced by a publicly known process. Capable of being adopted are, for example, (i) a multistage polymerization process in which homopolypropylene is produced in the first step and in which an ethylene-propylene copolymer part is then produced in the second step, (ii) a multistage polymerization process in which two or more kinds of homopolypropylenes having different molecular weights are produced in a multistage and in which an ethylene-propylene copolymer part is then produced, (iii) a multistage polymerization process in which homopolypropylene is produced in the first step and in which an ethylene-propylene copolymer part is then produced in the second step and a polymerization process in which two or more kinds of ethylene-propylene copolymer parts having different ethylene amounts and molecular weights are then produced in a multistage and (iv) a process in which homopolypropylene and an ethylene-propylene copolymer are blended by conventional melt kneading or solution mixing.

[i] Component (component A) which is Insoluble in 25° C. p-xylene and Boiling n-heptane

(a) In the propylene-ethylene block copolymer in the polypropylene-based composite resin composition of the present invention, the component which is insoluble in 25° C. p-xylene and boiling n-heptane is obtained by the following method.

Namely, (1) 5±0.5 g of a sample is precisely weighed and put in a Kjeldahl flask of 1000 milliliter, and 1±0.05 g of BHT (antioxidant) is added thereto. Then, a rotor and 700±10 milliliter of paraxylene are put thereinto.

Next, (2) the Kjeldahl flask is equipped with a condenser and heated on an oil bath of 140±5° C. for 120±30 minutes while working the rotor to dissolve the sample in paraxylene. Then, the content of the flask is poured into a beaker of 1000 milliliter, and then a solution contained in the beaker is left cooling (8 hours or longer) down to 25° C. while stirring by means of the rotor, followed by filtering the deposit through a wire gauze. This deposit filtered through the gauze is dissolved again in paraxylene according to the method described in above (1) and (2) and quickly transferred into 2000±100 milliliter of methanol contained in a beaker of 3000 milliliter while kept hot, and it is stirred for 2 hours or longer by means of the rotor, followed by leaving at a room temperature (25° C.) for a night.

Next, after filtering the deposit through the gauze, it is air-dried for 5 hours or longer and then dried in a vacuum dryer at 100±5° C. for 240 to 270 minutes to obtain a p-xylene-insoluble matter. The p-xylene-insoluble matter 1 g thus obtained is extracted in boiling n-heptane for 6 hours by means of a Soxhlet extractor, and an insoluble part is air-dried for 5 hours or longer and then dried in a vacuum dryer at 60±5° C. for 240 to 270 minutes to obtain a part which is insoluble in p-xylene and insoluble in boiling n-heptane.

(b) The stereoregularity index Ic is measured by the following method.

The stereoregularity index Ic is determined by measuring the component which is insoluble in 25° C. p-xylene and boiling n-heptane by means of ¹³C-NMR to calculate from the following equation using heights Pₘₘₘₘ, Pₘₘₘᵣ, Pₘₘᵣᵣ, Pₘₘᵣₘ₊ᵣᵣₘᵣ, Pᵣᵣᵣᵣ and Pₘᵣᵣₘ of absorption peaks originating in mmmm (chemical shift, 21.86 ppm), mmmr (21.62 ppm), mmrr (21.07 ppm), mmrm+rrmr (20.88 ppm), rrrr (20.36 ppm) and mrrm (19.95 ppm) in a methyl area:
Ic=[Pₘₘₘₘ×100]/[Pₘₘₘₘ+Pₘₘₘᵣ+Pₘₘᵣᵣ+Pₘₘᵣₘ+Pₘₘᵣₘ₊ᵣᵣₘᵣ+Pᵣᵣᵣᵣ+Pₘᵣᵣₘ]

Pₘₘₘₘ, Pₘₘₘᵣ, Pₘₘᵣᵣᵣ, Pₘₘₘ₊ᵣᵣₘᵣ, Pᵣᵣᵣᵣ and Pₘᵣᵣₘ are determined by heights from the corresponding respective peaks.

On the other hand, the peak originating in mmmr is superposed on tailing of the peak originating in mmmm, and therefore a height contributed by the tailing of mmmm is deducted from a height from the base line of mmmr according to an ordinary method to determine Pₘₘₘᵣ.

Further, ¹³C-NMR is measured on the following conditions:

| | |
|---|---|
| Solvent: 1,2,4-trichlorobenzene/heavy | 150 mg/3 milliliter |
| benzene (90:10 | |
| volume %) mixed solvent | |
| Concentration: | |
| Dissolving temperature: | 140° C. |
| Measuring apparatus: | JNM-EX400 NMR apparatus |
| | manufactured |
| | by JEOL Co., Ltd. |
| Pulse width: | 8.7 μs/45° |
| Pulse interval: | 4 seconds (s) |
| Measuring temperature: | 130° C. |
| Accumulation: | 1000 times |

[ii] Component (Component B) which is Soluble in p-xylene

(a) In the propylene-ethylene block copolymer in the polypropylene-based composite resin composition of the present invention, the component which is soluble in 25° C. p-xylene is obtained by the following method.

That is, 5±0.5 g of a sample is precisely weighed and put in a Kjeldahl flask of 1000 milliliter, and 1±0.05 g of BHT (antioxidant) is added thereto. Then, a rotor and 700±10 milliliter of paraxylene are put thereinto. Next, the Kjeldahl flask is equipped with a condenser and heated on an oil bath of 140±5° C. for 120±30 minutes while working the rotor to dissolve the sample in paraxylene.

Next, the content of the flask is poured into a beaker of 1000 milliliter, and then a solution contained in the beaker is left cooling (8 hours or longer) down to 25° C. while stirring by means of the rotor, followed by filtering the deposit through wire gauze. Further, the filtrate is filtered through a filter paper, and this filtrate is poured into 2000±100 milliliter of methanol contained in a beaker of 3000 milliliter to leave this liquid standing at a room temperature (25° C.) for 2 hours or longer while stirring by means of the rotor. Next, after filtering the deposit through the wire gauze, it is air-dried for 5 hours or longer and then dried in a vacuum dryer at 100±5° C. for 240 to 270 minutes to recover a p-xylene-soluble component.

A content (X) of the p-xylene-soluble component is shown by the following equation:
X(mass %)=[C/A]×100
wherein A (g) represents a sample weight, and C (g) represents a weight of the soluble component recovered by the method described above.

(b) Measurement of an Ethylene Content in the p-xylene-soluble Component

An ethylene content in the p-xylene-soluble part is determined by ¹³C-NMR measurement according to the following method.

The ethylene content in the p-xylene-soluble part is evaluated by a ¹³C-NMR method to obtain integrated intensities I(T_{δδ}), I(T_{βδ}), I(S_{γδ}), I(S_{δδ}), I(T_{ββ}), I(S_{βδ}) and I(S_{ββ}) of peaks assigned to T_{δδ}, T_{βδ}, S_{γδ}, S_{δδ}, T_{ββ}, S_{βδ} and S_{ββ} carbons.

Then, the above integrated intensities are used to calculate fractions f_{EEE}, f_{EPE}, f_{PPE}, F_{PPP}, f_{PEE} and F_{PEP} in EEE, EPE, PPE, PPP, PEE and PEP triad chain distributions by the following equations:
f_{EEE}: [I(S_{δδ})/2+I(S_{γδ})/4]/[I(S_{δδ})/2+I(S_{γδ})/4+I(T_{δδ)]+}I(T_{βδ})+I(T_{ββ})+I(S_{βδ})+I(S_{ββ})]
f_{EPE}=I(T_{δδ})/[I(S_{δδ})/2+I(S_{γδ})/4+I(T_{δδ})]+I(T_{βδ})+I(T_{ββ})+I(S_{ββ})+I(S_{ββ})]
f_{PPE}=I(T_{βδ})/[I(S_{δδ}/2+I(S_{γδ})/4+I(T_{δδ})]+I(T_{βδ)+}I(T_{ββ})+I(S_{γδ})+I(S_{ββ})]
f_{PEE}=I(S_{βδ})/[I(S_{δδ})/2+I(S_{γδ})/4+I(T_{δδ})]+I(T_{βδ})+I(T_{ββ})+I(S_{βδ})+I(S_{ββ})]
f_{PEP}=I(S_{ββ})/[I(S_{δδ})/2+I(S_{γδ})/4+I(T_{δδ})]+I(T_{βδ})+I(T_{ββ})+I(S_{βδ})+I(S_{ββ})]

Accordingly, the ethylene content (mole %) [Et (mole %)] can be calculated by the following equation using the above fractions:
ethylene amount (mole %)=100×[f_{EEE}+2(f_{EEP}+f_{EPE})/3+(f_{PEP}+f_{PPE})/3]×3

Namely, the ethylene amount (mass %) can be calculated by the following equation:
ethylene amount (mass %)=[28 Et (mole %)/{28 Et (mole %)+42(100−Et (mole %)}]×100

The conditions in ¹³C-NMR measurement are the same as the conditions in measuring the component (component A) which is insoluble in 25° C. p-xylene and boiling n-heptane.

The elastomer in the polypropylene-based composite resin composition of the present invention has a melt index (MI) of 0.5 to 20 (230° C., 2.16 kgf).

Adjusting the MI to 5 or more increases the fluidity in filling to cause no such failures as burrs. On the other hand, regulating the MI to 20 or less elevates the viscosity at ω of 0.1 rad/s and therefore makes surface formation failure and deformation less liable to occur.

The elastomer includes, for example, ethylene-α-olefin copolymers, styrene-ethylene/propylene-styrene triblock copolymers, styrene-(ethylene/1-butene)-styrene triblock copolymers, styrene-(ethylene/propylene)-styrene copolymers, styrene-(ethylene/1-butene) block copolymers, rubbers which are obtained by hydrogenating a butadiene part in styrene-butadiene-styrene copolymers and in which a hydrogenating rate is 95 mole % or less and diblock (block I-block II) copolymers or triblock (block I-block II-block I) copolymers comprising a butadiene block (block I) having a 1-2 vinyl bond of 20 mole % or less and a butadiene block (block II) having a 1-2 vinyl bond of 50 to 80 mole %.

A content of talc in the polypropylene-based composite resin composition of the present invention is 0 to 40 mass %. Regulating the content to 40 mass % or less increases the fluidity in filling to cause no such failures as burrs.

Talc used in the present invention has an average particle diameter of 10 μm or less. Regulating the particle diameter to 10 μm or less elevates the viscosity at ω of 0.1 rad/s and the shear storage modulus at ω of 0.0251 rad/s, and therefore it makes surface formation failure and deformation less liable to occur while shortening the pressure-holding time and makes stringing less liable to take place while shortening the cooling time.

The average particle diameter of talc was measured by means of a particle size distribution meter of a laser beam diffraction scattering system in accordance with a measuring principle described in “Particle Measuring Technology (edited by The Society of Powder Technology, Japan published by The Nikkan Kogyo Shinbun, Ltd. on Nov. 1, 1994)”.

SALD-2000 manufactured by Shimadzu Corporation was used for the measuring apparatus. A value of 1.60-0.10i was used as a refractive index of talc.

A content of fine powder silica is 0.3 to 10 mass %. Adjusting the content of fine powder silica to 0.3 mass % or more elevates the viscosity at ω of 0.1 rad/s and the shear storage modulus at ω of 0.0251 rad/s, and therefore it makes surface formation failure and deformation less liable to occur while shortening the pressure-holding time and makes stringing less liable to take place while shortening the cooling time.

Further, regulating the content of fine powder silica to 10 mass % or less increases the fluidity in filling to cause no such failures as burrs.

Fine powder silica used in the present invention has a primary particle diameter of 0.1 μm or less.

Regulating the primary particle diameter to 0.1 μm or less elevates the viscosity at ω of 0.1 rad/s and the shear storage modulus at ω of 0.0251 rad/s, and therefore it makes surface formation failure and deformation less liable to occur while shortening the pressure-holding time and makes stringing less liable to take place while shortening the cooling time.

Fine powder silica includes precipitated silica, silica gel and Aerosil, and Aerosil is preferred.

The primary particle diameter of fine powder silica was measured in the following manner.

Fine powder silica is dusted on a grid having a collodion support film, and surplus powder is simply removed by means of a blower, followed by observing under a transmission type electron microscope.

The average primary particle diameter of fine powder silica was determined from the above transmission type electron microphotograph in accordance wit Journal of Material Science 1211, 21 (1986).

The specific examples of the nucleating agent used for the polypropylene-based composite resin composition of the present invention includes high melting polymers, organic carboxylic acids or metal salts thereof, aromatic sulfonic acid salts or metal salts thereof, organic phosphoric acid compounds or metal salts thereof, dibenzylidenesorbitol or derivatives thereof, rodinic acid partial metal salts, inorganic fine particles, imides, amides, quinacridones, quinones or mixtures thereof.

The above nucleating agents may be used alone or in combination of two or more kinds thereof.

The high melting polymers include polyolefins such as polyethylene and polypropylene, polyvinylcycloalkanes such as polyvinylcyclohexane and polyvinylcyclopentane, syndiotactic polystyrene, poly(3-methylpentene-1), poly(3-methylbutene-1), polyalkenylsilane, etc.

The metal salts include aluminum benzoate, aluminum p-t-butylbenzoate, sodium adipate, sodium thiophenecarboxylate, sodium pyrrolecarboxylate, etc.

Dibenzylidenesorbitol or the derivatives thereof include dibenzylidenesorbitol, 1,3:2,4-bis(o-3,4-dimethylbenzylidene)sorbitol, 1,3:2,4-bis(o-2,4-dimethylbenzylidene)sorbitol, 1,3:2,4-bis(o-4-ethylbenzylidene)sorbitol, 1,3:2,4-bis(o-4-chlorobenzylidene)sorbitol and 1,3:2,4-dibenzylidenesorbitol.

To be specific, they include Gelol MD and Gelol MD-R (trade names) available from New Japan Chemical Co., Ltd.

The rodinic acid partial metal salts include Pine Crystal KM1600, Pine Crystal KM1500 and Pine Crystal KM1300 (trade names) available from Arakawa Chemical Industries, Ltd.

The inorganic fine particles include talc, clay, mica, asbestos, glass fibers, glass flakes, glass beads, calcium silicate, montmorillonite, bentonite, graphite, aluminum powder, alumina, silica, diatomaceous earth, titanium oxide, magnesium oxide, pumice powder, pumice balloon, aluminum hydroxide, magnesium hydroxide, basic magnesium carbonate, dolomite, calcium sulfate, potassium titanate, barium sulfate, calcium sulfite and molybdenum sulfide.

Among the above compounds, the inorganic fine particles such as talc and/or an organic phosphoric acid metal salt represented by the following formula: 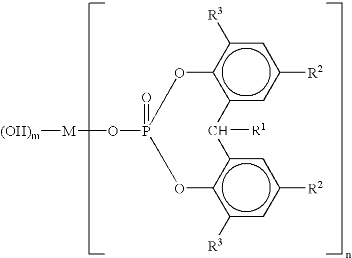
wherein R¹ represents a hydrogen atom or an alkyl group having 1 to 4 carbon atoms; R² and R³ each represent a hydrogen atom, an alkyl group having 1 to 12 carbon atoms, a cycloalkyl group, an aryl group or an aralkyl group; M represents any of alkaline metals, alkaline earth metals, aluminum and zinc; when M is alkaline metal, m represents 0, and n represents 1; when M is alkaline earth metal or zinc, n represents 1 or 2; when n is 1, m represents 1, and when n is 2, m represents 0; when M is aluminum, m represents 1, and n represents 2;
are preferably used for the polypropylene-based composite resin composition of the present invention since less odor generates.

The specific examples of the organic phosphoric acid metal salts include Adeka Stab NA-11 and Adeka Stab NA-21 (available from Asahi Denka Co., Ltd.).

The amide compounds include adipic acid dianilide and suberic acid dianilide.

A content of the nucleating agent used in the present invention is preferably 0.0 to 0.3 mass %.

### EXAMPLES

Next, the present invention shall be explained in further details with reference to examples, but the present invention shall by no means be restricted by these examples.

[Production of Propylene-ethylene Block Copolymer]

(1) Preparation of Catalyst

(i) Preparation of Magnesium Compound

A glass-made reactor having a content volume of 6 liter equipped with a stirrer was sufficiently replaced with nitrogen gas and charged with about 2400 g of ethanol (extra pure reagent, manufactured by Wako Pure Chemical Industries, Ltd.), 16 g of iodine (extra pure reagent, available from Wako Pure Chemical Industries, Ltd.) and 160 g of granular metal magnesium having an average particle diameter of 350 μm, and they were reacted while stirring under a refluxing condition until hydrogen gas was not observed to be generated from the system to obtain a solid product. A reaction liquid containing this solid product was dried up under reduced pressure, whereby a magnesium compound (solid product) was obtained.

(ii) Preparation of Solid Catalyst Component

A glass-made three neck flask having a content volume of 500 milliliter which was sufficiently replaced with nitrogen gas was charged with 16 g of the magnesium compound obtained in (i) described above, 80 milliliter of refined heptane, 2.4 milliliter of silicon tetrachloride and 2.3 milliliter of diethyl phthalate. The inside of the system was maintained at 90° C., and 77 milliliter of titanium tetrachloride was added thereto while stirring and reacted at 110° C. for 2 hours. Then, 122 milliliter of titanium tetrachloride was further added and reacted at 110° C. for 2 hours, and then the reaction product was sufficiently washed with refined heptane to obtain a solid catalyst component.

(iii) Preliminary Polymerization

A three neck flask of 5 liter equipped with a glass-made stirrer and a thermometer was used, and 4 liter of heptane which was dehydrated by a molecular sieve 4A and nitrogen bubbling was added thereto under nitrogen flow. Thereafter, 26.8 millimole of triethylaluminum (TEA), then 2.5 millimole of dicyclopentyldimethoxysilane (DCPDMS) and further 5.3 millimole (3.8 g—solid catalyst) per Ti atom of the solid catalyst component were added thereto at 25° C. while stirring.

Next, propylene was continuously added at a room temperature while stirring to carry out preliminary polymerization so that a 0.3 time amount of polypropylene per solid catalyst component was produced. This product was used as a preliminary polymerization catalyst for the following polymerization.

(iv) Production of Polypropylene

Polymerization of Propylene

A pressure proof autoclave of 10 liter which was well replaced with nitrogen and dried was charged under nitrogen flow with 6 liter of n-heptane which was well dehydrated with a molecular sieve. Next, added thereto were 7.5 millimole of triethylaluminum (TEA) and 0.5 millimole of DCPDMS, and then nitrogen was replaced with propylene at 80° C. to introduce hydrogen of 4.0 kg/cm² G through a precision gauge. Further, propylene was introduced while stirring until the pressure reached 8.0 kg/cm² G. Next, 0.05 millimole of the preliminary polymerization catalyst in terms of a Ti atom obtained in (iii) described above was added thereto, and then propylene was continuously introduced so that the pressure reached 8.0 kg/cm² G to carry out reaction for 2 hours while maintaining the polymerization temperature at 80° C.

Next, the inside of the autoclave was replaced with propylene, and then hydrogen was introduced at 0.2 kg/cm² G to elevate the pressure up to 4.0 kg/cm² G while maintaining the temperature at 80° C. to carry out polymerization reaction for 30 minutes.

A reaction weight ratio at the first stage and the second stage in the above propylene homopolymerization was roughly calculated using a value of an integrating flow meter to find that the reaction amount at the second stage was 8% based on the whole reaction amount.

Polymerization of Propylene-ethylene

A small amount of polypropylene was sampled after reducing the pressure in the system, and the inside of the autoclave was replaced with propylene, followed by introducing hydrogen of 0.01 kg/cm² G. Ethylene/propylene was continuously introduced at a flowing ratio of 0.35/1.0 to carry out polymerization at a pressure of 5.0 kg/cm² G and 57° C. for 20 minutes.

After reducing the pressure down to an atmospheric pressure, a polymerized powder containing n-heptane was separated at 57° C. by means of a stainless gauze of 400 mesh, and it was further washed with 4 liter of n-heptane of 57° C. for 30 minutes while stirring. Then, the powder was separated again by means of the gauze of 400 mesh and dried to obtain 2.15 kg of a propylene-ethylene block copolymer.

Various physical properties of the above propylene-ethylene block copolymer are shown in Table 1.

### EXAMPLES 1 TO 5 AND COMPARATIVE EXAMPLES 1 TO 4

1. Raw Materials Used for Blending

(i) Propylene-ethylene Block Copolymer

The propylene-ethylene block copolymer produced above was used.

(ii) Elastomer

SEBS [styrene-(ethylene/1-butene)-styrene triblock copolymer]: styrene amount 18 mass %, MI=4.0, EOM (ethylene-1-octene rubber): density 0.863 g/cm³, MI=1.4, EBM (ethylene-1-butene rubber): density 0.863 g/cm³,

(iii) talc: average particle diameter 4 μm, FFR available from by Asada Seihun Co., Ltd.,

(iv) fine powder silica: Aerosil A-1 (primary particle diameter 15 nm), and

(v) nucleating agent: organic phosphoric acid ester metal salt base nucleating agent N-1 [sodium 2,2′-methylenebis-(4,6-di-butylphenyl) phosphate] for elevating a polypropylene crystallization temperature], N-2 (aluminum p-t-butylbenzoate).

2. Production of Polypropylene-Based Composite Resin Composition

With the use amounts shown in Table 2 or Table 3, an antioxidant was added to a mixture comprising the propylene-ethylene block copolymer, the elastomer and optionally, talc and fine powder silica, and then it was mechanically kneaded at a predetermined temperature of 200° C. and a screw speed of 900 rpm by means of an anisotropic biaxial kneader (2FCM, manufactured by Kobe Steel Ltd.). A strand was formed therefrom by means of an extruding machine and then pelletized by means of a pelletizer to prepare a polypropylene-based composite resin composition. Then, it was sufficiently dried to obtain a raw material for molding.

The above polypropylene-based composite resin composition was measured for a capillary viscosity, a complex viscosity η*, a shear storage modulus G′ and a crystallization temperature.

Further, the molded article was evaluated for surface formation, deformation and stringing.

The measuring methods of the capillary viscosity, the complex viscosity η*, the shear storage modulus G′ and the crystallization temperature and the evaluating methods of surface formation, deformation and stringing of the molded article will be described below.

3. Measurement of Capillary Viscosity

The capillary viscosity was measured on the conditions of L/D=40/1 and at 190° C. using a capillograph manufactured by Toyo Seiki Seisakusho, Ltd. The results thereof are shown in Table 2 and Table 3.

4. Measurement of Complex Viscosity η* and Shear Storage Modulus G′

An RMS apparatus manufactured by Rheometrix Co., Ltd. was equipped with a conical disc viscometer to measure the complex viscosity η* and the shear storage modulus G′ at a distortion of 30% and a temperature of 190° C. at an angular frequency ω falling in a range of 0.01 to 100 rad/s to determine the value of η* at an angular frequency ω of 0.01 and the value of G′ at ω of 100, 10, 0.1, 0.01 and 0.0251 rad/s. The results thereof are shown in Table 2 and Table 3.

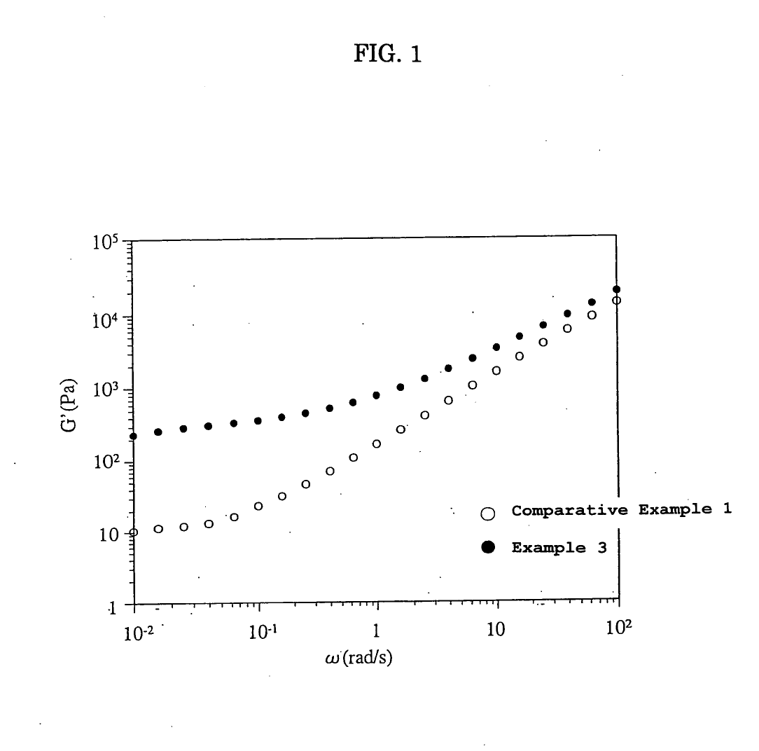

The relation of the angular frequency ω (X-axis) and the shear storage modulus G′ (Y-axis) in Example 3 and Comparative Example 1 is shown in FIG. 1.

5. Measurement of Crystallization Temperature

The crystallization temperature was measured by heating the sample at 220° C. for 3 minutes and then cooling it down to 50° C. at a cooling rate of 10° C./minute by means of DSC-7 manufactured by Perkin-Elmer Corporation, and the crystallization temperature was determined from a temperature in a peak of the resulting heat absorbing curve. The results thereof are shown in Table 2 and Table 3.

6. Evaluation of Surface Formation and Deformation

(i) Die Form
Molded article form: flat board having a length of 420 mm, a width of 100 mm and a thickness of 3 mm
Gate form: film gate having a width of 4 mm, a thickness of 1 mm and a length of 3 mm
Runner form: trapezoid; upper edge of 6 mm,
   lower edge of 8 mm,
   height of 7 mm;
distance from spool to gate was 440 mm.

(ii) Molding Conditions
Molding machine: IS200CNNH manufactured by Toshiba Machine Co., Ltd.
Settled temperatures for cylinder: nozzle: 210° C.,

H1: 220° C., H2: 210° C., H3 (under hopper): 200° C.

| | |
|---|---|
| Die temperature set: | 40° C. |
| Injection pressure: | 100 kg/cm² |
| Screw speed: | 100 rpm |
| Filling time: | 2 seconds |

(iii) Determination of Pressure Holding Time Before Surface Formation Failure and Deformation Disappear

The die shown in (ii) described above was used to prepare a molded article on the molding conditions described in above (i) by fixing a cooling time of 13 seconds (s) and changing the pressure holding time, and the pressure holding time before the surface formation failure and the deformation disappeared was determined as a result. The results thereof are shown in Table 2 and Table 3.

7. Evaluation of Stringing

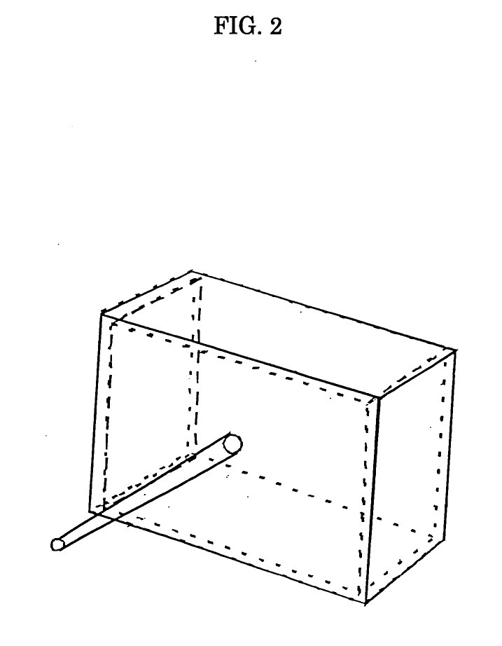

(i) Die
Product form: box type product having a height of 100 mm, a length of 75 mm, a width of 45 mm and a thickness of 2 mm; the product form is shown in FIG. 2.
Gate: direct gate

(ii) Molding Conditions

| | |
|---|---|
| Molding machine: | IS100FIII manufactured by Toshiba |
| | Machine Co., Ltd. |
| Settled temperatures | NH (under nozzle): 160° C., |
| for cylinder: | H1: 200° C., H2; 200° C., |
| | H3: 200° C. |
| Die temperature: | fixed side; settled temperature of 15° C., |
| | moving side; settled temperature of 40° C., |
| Injection pressure: | 17 kg/cm², |
| Holding pressure: | 20 kg/cm² |
| Sum of filling time | |
| and pressure holding time: | 7 seconds |
| Holding pressure- | 15 mm |
| switching position: | |
| Die opening: | the dies were opened up to 310 mm |
| | (space between the dies) at 30 m/minute |
| | and then up to 360 mm at 7 m/minute |

(iii) Cooling Time Before Stringing Disappears

The cooling time was changed to observe a length of stringing appearing on a tip of a spool of the molded article.

Time in which a length of all stringing in ten molded articles became 2 cm or less was determined as the cooling time. The results thereof are shown in Table 2 and Table 3.

TABLE 1

| | | | Polypropylene |
|---|---|---|---|
| | | Unit | part |
| Component | Stereoregularity | % | 99.2 |
| insoluble | [Ic] | | |
| in 25° C. | Intrinsic | dl/g | 0.81 |
| xylene and | viscosity [η] | | |
| boiling n- | Content | mass % | 92.0 |
| heptane | | | |
| Component | Ethylene content | mass % | 33.0 |
| soluble in | Intrinsic | dl/g | 6.4 |
| 25° C. | viscosity [η] | | |
| xylene | Content | mass % | 5.6 |

TABLE 2

| | | Example | | | | |
|---|---|---|---|---|---|---|
| | | 1 | 2 | 3 | 4 | 5 |
| Propylene-ethylene | | 52.9 | 52.9 | 51.9 | 66.0 | 52.9 |
| copolymer (mass %) | | | | | | |
| Rubber | Rubber 1 (mass %) | EOM 25 | SEBS 5 | SEBS 5 | EOM 30 | EOM 25 |
| | Rubber 2 (mass %) | — | EOM 20 | EOM 20 | — | — |

| Talc (mass %) | | 20 | 20 | 20 | — | 20 |
|---|---|---|---|---|---|---|
| Fine powder silica | | 1.9 | 1.9 | 2.9 | 3.8 | 1.9 |
| (mass %) | | | | | | |
| Nucleating | Kind | N-1 | N-1 | N-1 | N-1 | N-2 |
| agent | (mass %) | 0.2 | 0.2 | 0.2 | 0.2 | 0.2 |

| | | | | | |
|---|---|---|---|---|---|
| Complex viscosity η* | 5740 | 7700 | 6800 | 3385 | 5800 |
| (Pa · s) | | | | | |
| log (G′₁₀₀) − log (G′₁₀) | 0.87 | 0.82 | 0.77 | 0.84 | 0.88 |
| log (G′_{0.1}) − log (G′_{0.01}) | 0.13 | 0.16 | 0.19 | 0.06 | 0.14 |
| Shear storage modulus | | | | | |
| G′_{0.0251} (Pa) | 237 | 324 | 300 | 131 | 242 |
| Capillary viscosity (Pa · s) | 76 | 76 | 76 | 73 | 75 |
| Crystallization | 130 | 131 | 131 | 130 | 130 |
| temperature (° C.) | | | | | |
| Pressure holding time | 20 | 18 | 18 | 22 | 20 |
| before surface formation | | | | | |
| failure and deformation | | | | | |
| disappear (seconds) | | | | | |
| Cooling time before | 20 | 15 | 15 | 45 | 20 |
| stringing disappear | | | | | |
| (seconds) | | | | | |

TABLE 3

| | | Comparative Example | | | |
|---|---|---|---|---|---|
| | | 1 | 2 | 3 | 4 |
| Propylene-ethylene | | 69.8 | 69.8 | 69.8 | 69.8 |
| copolymer (mass %) | | | | | |
| Rubber | Rubber 1 (mass %) | EOM 30 | EBM 30 | SEBS 5 | SEBS 30 |
| | Rubber 2 (mass %) | — | — | EOM 25 | EBM 25 |

| | | | | |
|---|---|---|---|---|
| Talc (mass %) | — | — | — | — |
| Fine powder silica | — | — | — | — |
| (mass %) | | | | |
| Nucleating agent | 0.2 | 0.2 | 0.2 | 0.2 |
| (mass %) | | | | |
| Complex viscosity η* | 1310 | 1430 | 1570 | 1790 |
| (Pa · s) | | | | |
| log (G′₁₀₀) − log (G′₁₀) | 0.93 | 0.97 | 0.90 | 0.90 |
| log (G′_{0.1}) − log (G′_{0.01}) | 0.35 | 0.22 | 0.26 | 0.12 |
| Shear storage modulus | 13.5 | 10 | 14.5 | 31 |
| G′_{0.0251} (Pa) | | | | |
| Capillary viscosity (Pa · s) | 66 | 68 | 65 | 66 |
| Crystallization temperature (° C.) | 130 | 130 | 130 | 130 |
| Pressure holding time | 24 | 24 | 24 | 24 |
| before surface formation | | | | |
| failure and deformation | | | | |
| disappear (seconds) | | | | |

### INDUSTRIAL APPLICABILITY

In accordance with the present invention, the polypropylene-based composite resin composition reveals less liability to cause failures such as short shot, burrs, surface formation failure, deformation and stringing even when a molding cycle in injection molding is shortened.

Accordingly, a molding cycle can be shortened, and therefore the number of the products produced a day is increased, so that the cost can be reduced.

1. A polypropylene-based composite resin composition in which:
(1) a complex viscosity η* at 190° C. and an angular frequency (ω) of 0.1 rad/s is 2000 Pa·s or more,
(2) shear storage moduli G′₁₀₀, G′₁₀, G′_{0.1} and G′_{0.01} at 190° C. and angular frequencies (ω) of 100, 10, 0.1 and 0.01 rad/s satisfy an equation (I) and an equation (II):
log (G′₁₀₀)−log(G′₁₀)≧=0.6 (I)
log (G′_{0.1})−log(G′_{0.01})≦0.4 (II)
and
(3) a shear storage modulus G′_{0.0251} at 190° C. and an angular frequency of 0.0251 rad/s is 60 Pa or more.

2. The polypropylene-based composite resin composition as described in claim 1, wherein a capillary viscosity at 190° C. and a shear rate γ of 1216 s⁻¹ is 100 Pa·s or less, and a crystallization temperature at a cooling rate of 10° C./minute measured by means of a differential scanning calolimeter (DSC) is 120° C. or higher.

3. The polypropylene-based composite resin composition as described in claim 1 or 2, comprising (1) 95 to 50 mass % of a propylene-ethylene block copolymer which comprises (A) a component having a intrinsic viscosity [η] (in decalin of 135° C.) of 0.3 to 2.0 and a stereoregularity index Ic of 95% or more and insoluble in 25° C. p-xylene and boiling n-heptane in an amount of 60 to 96 mass % and (B) a component having an intrinsic viscosity [η] (in decalin of 135° C.) of 1.5 to 9.0, containing 10 mass % or more of a unit originating in ethylene and soluble in 25° C. p-xylene in an amount of 4 to 40 mass % and which has a melt index (MI) of 20 or more (230° C., 2.16 kgf),
(2) 5 to 30 mass % of at least one kind of elastomer having a melt index (MI) of 0.5 to 20 (230° C., 2.16 kgf),
(3) 0 to 40 mass % of talc having an average particle diameter of 10 μm or less,
(4) 0.3 to 10 mass % of fine powder silica having a primary particle diameter of 0.1 μm or less and
(5) 0.0 to 0.3 mass % of a nucleating agent.

4. The polypropylene-based composite resin composition as described in claim 3, wherein the elastomer is a copolymer of ethylene and α-olefin.

5. The polypropylene-based composite resin composition as described in claim 3, wherein the elastomer is a styrene-(ethylene/1-butene)-styrene triblock copolymer (SEBS) or a styrene-(ethylene/propylene)-styrene triblock copolymer (SEPS).

6. The polypropylene-based composite resin composition as described in claim 3, wherein the elastomer comprises a copolymer of ethylene and α-olefin, and at least one selected from a styrene-(ethylene/1-butene)-styrene triblock copolymer (SEBS) or a styrene-(ethylene/propylene)-styrene triblock copolymer (SEPS).

7. The polypropylene-based composite resin composition as described in claim 3, wherein the fine powder silica is Aerosil.
